(19) United States
(12) Patent Application Publication
(10) Pub. No.: US 2026/0322578 A1
(43) Pub. Date: Oct. 15, 2026

(54) DEVICES AND METHODS FOR PUSCH AND DMRS TRANSMISSION

(71) Applicant: Lenovo (Beijing) Limited, Beijing (CN)

(72) Inventors: Yuantao Zhang, Beijing (CN); Ruixiang Ma, Beijing (CN); Zhi Yan, Beijing (CN)

(73) Assignee: Lenovo (Beijing) Limited, Beijing (CN)

(21) Appl. No.: 19/481,080

(22) PCT Filed: May 12, 2023
(86) PCT No.: PCT/CN2023/094029

§ 371 Date: Nov. 3, 2025

(51) Int. Cl. H04L 5/14; H04L 5/00

(52) U.S. Cl. CPC H04L 5/143; H04L 5/0094

(57) ABSTRACT

A method for physical uplink shared channel (PUSCH) and demodulation reference signal (DMRS) transmission is disclosed. A terminal device receives a configuration for physical uplink shared channel (PUSCH) repetitions and a demodulation reference signal (DMRS) from a network device (910). Based on the configuration, the terminal device determines at least one of a startpoint for PUSCH symbols or a start point for at least one DMRS symbol in a DL slot with SBFD symbols (920). Based on the at least one of start point for the PUSCH symbols or the start point for the at least one DMRS symbol, the terminal device determines at least one symbol for PUSCH transmission and at least one symbol for DMRS transmission in the DL slot with the SBFD symbols (930). In this way, PUSCH transmission latency is reduced and UL subband utilization efficiency is improved, and thus the performance of communications is improved.

### FIELD

Embodiments of the present disclosure generally relate to the field of communication, and in particular to devices, methods, and a non-transitory computer readable medium for physical uplink shared channel (PUSCH) and demodulation reference signal (DMRS) transmission.

### BACKGROUND

In wireless communication system, the term “duplex” means bidirectional communication between two devices, where the transmissions over the link in each direction may take place at the same time (i.e., full duplex) or mutual exclusive time (i.e., half duplex). In legacy full duplex transceivers, different carrier frequencies are employed for each link direction. This is known as full duplex frequency division duplex (FD-FDD). Conversely, in a half-duplex (HD) transceiver, the link directions are separated by time domain resources.

Advanced full duplex modes enable simultaneous transmission and reception by the same device on the same carrier, thus having the potential to double the link throughput. The transmission latency is also reduced thanks to bidirectional transmission simultaneously. However, simultaneous downlink (DL) and uplink (UL) in a same carrier will incur self-interference. On the base station (BS) side, this means DL transmission contaminates UL reception, while in the UE side, the UL transmission might contaminate DL reception. Enhancements on PUSCH and DMRS transmission are still needed.

### SUMMARY

In general, example embodiments of the present disclosure provide devices, methods and a computer readable medium for PUSCH and DMRS transmission.

In a first aspect, there is provided a terminal device. The terminal device comprises a processor and a transceiver coupled to the processor. The processor is configured to receive, via the transceiver from a network device, a configuration for physical uplink shared channel (PUSCH) repetitions and a demodulation reference signal (DMRS); determine, based on the configuration, at least one of a start point for the PUSCH symbols or a start point for at least one DMRS symbol in a downlink (DL) slot with subband full duplex (SBFD) symbols; and determine, via the transceiver based on the at least one of the start point for the PUSCH symbols or the start point for the at least one DMRS symbol, at least one symbol for PUSCH transmission and at least one symbol for DMRS transmission in the DL slot with the SBFD symbols.

In a second aspect, there is provided a network device. The network device comprises a processor; and a transceiver coupled to the processor. The processor is configured to transmit, via the transceiver to a terminal device, a configuration for physical uplink shared channel (PUSCH) repetitions and a demodulation reference signal (DMRS); determine, based on the configuration, at least one of a start point for the PUSCH symbols or a start point for at least one DMRS symbol in a downlink (DL) slot with subband full duplex (SBFD) symbols; and monitor, based on the at least one of the start point for the PUSCH symbols or the start point for the at least one DMRS symbol, the at least one symbol for PUSCH transmission and the at least one symbol for DMRS transmission in the DL slot with the SBFD symbols.

In a third aspect, there is provided a method performed by a terminal device. The method comprises receiving, via the transceiver from a network device, a configuration for physical uplink shared channel (PUSCH) repetitions and a demodulation reference signal (DMRS); determining, based on the configuration, at least one of a start point for the PUSCH symbols or a start point for at least one DMRS symbol in a downlink (DL) slot with subband full duplex (SBFD) symbols; and determining, via the transceiver based on the at least one of the start point for the PUSCH symbols or the start point for the at least one DMRS symbol, the at least one symbol for PUSCH transmission and the at least one symbol for DMRS transmission in the DL slot with the SBFD symbols.

In a fourth aspect, there is provided a method performed by a network device. The method comprises transmitting, via the transceiver to a terminal device, a configuration for physical uplink shared channel (PUSCH) repetitions and a demodulation reference signal (DMRS); determining, based on the configuration, at least one of a start point for the PUSCH symbols or a start point for at least one DMRS symbol in a downlink (DL) slot with subband full duplex (SBFD) symbols; and monitoring, based on the at least one of the start point for the PUSCH symbols or the start point for the at least one DMRS symbol, the at least one symbol for PUSCH transmission and the at least one symbol for DMRS transmission in the DL slot with the SBFD symbols.

In a fifth aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates an example network environment in which some embodiments of the present disclosure can be implemented;

FIG. 1B illustrates example duplex modes related to some embodiments of the present disclosure;

FIG. 1C illustrates an example transmission scenario related to some embodiments of the present disclosure;

FIG. 1D illustrates an example PUSCH repetitions related to some embodiments of the present disclosure;

FIG. 1E illustrates another example PUSCH repetition related to some embodiments of the present disclosure;

FIG. 1F illustrates example slots related to some embodiments of the present disclosure;

FIG. 2 illustrates an example signaling chart illustrating an example process according to some embodiments of the present disclosure;

FIG. 3 illustrates an example PUSCH resource allocation according to some embodiments of the present disclosure;

FIG. 4 illustrates an example PUSCH and DMRS resource allocation according to some embodiments of the present disclosure;

FIG. 5 illustrates another example PUSCH resource allocation according to some embodiments of the present disclosure;

FIG. 6 illustrates another example PUSCH and DMRS resource allocation according to some embodiments of the present disclosure;

FIG. 7 illustrates another example PUSCH and DMRS resource allocation according to some embodiments of the present disclosure;

FIG. 8 illustrates yet another example PUSCH and DMRS resource allocation according to some embodiments of the present disclosure;

FIG. 9 illustrates a flowchart of a method implemented at a terminal device according to some embodiments of the present disclosure;

FIG. 10 illustrates a flowchart of a method implemented at a network device according to some other embodiments of the present disclosure; and

FIG. 11 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, the term “communication network” refers to a network following any suitable communication standards, such as, 5G new radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

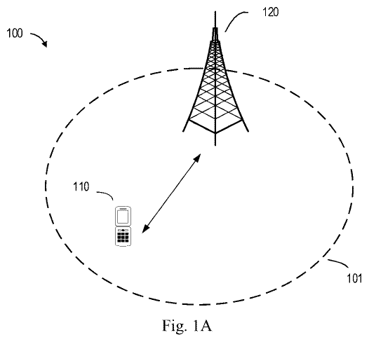

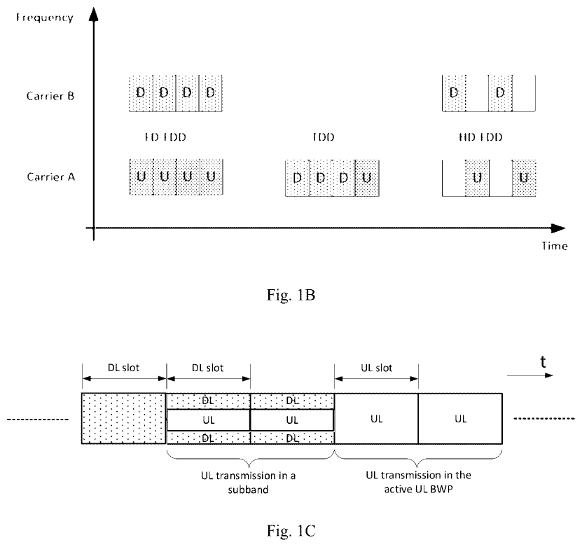

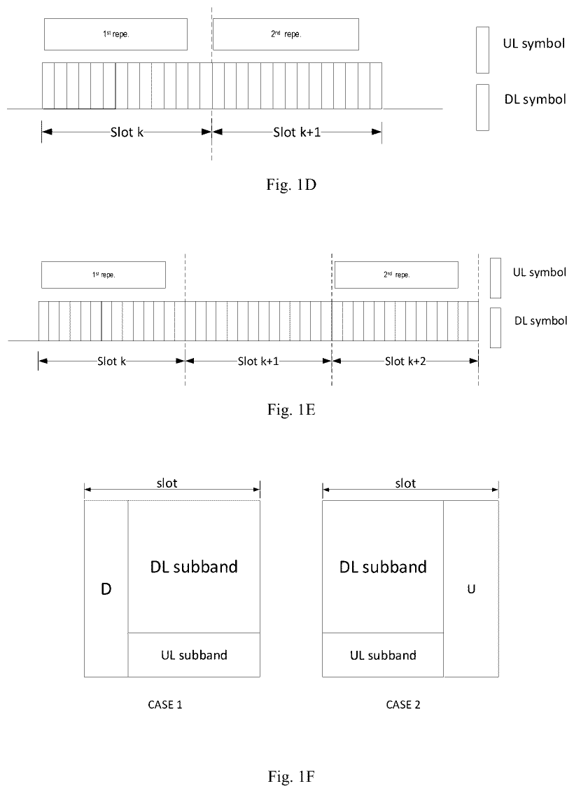

FIG. 1A illustrates an example network environment 100 in which example embodiments of the present disclosure may be implemented. The environment 100, which may be a part of a communication network, comprises terminal devices and network devices.

As illustrated in FIG. 1A, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In wireless communication system, the term “duplex” means bidirectional communication between two devices, where the transmissions over the link in each direction may take place at the same time (i.e., full duplex) or mutual exclusive time (i.e., half duplex).

In legacy full duplex transceivers, different carrier frequencies are employed for each link direction. This is known as full duplex frequency division duplex (FD-FDD). Conversely, in a half-duplex (HD) transceiver, the link directions are separated by time domain resources. When the same carrier frequency is used for each link direction, the HD transceiver is referred as a time division duplex (TDD) system, while if different carrier frequencies are used, the system is known as half duplex FDD (HD-FDD). FIG. 1B illustrates example duplex modes related to some embodiments of the present disclosure. As shown in FIG. 1B, there are FD-FDD mode, TDD mode and HD-FDD mode.

Advanced full duplex modes enable simultaneous transmission and reception by the same device on the same carrier, thus having potential to double the link throughput. The transmission latency is also reduced due to bidirectional transmission simultaneously. However, simultaneous DL and UL in a same carrier will incur self-interference. In the base station (BS) side, this means DL transmission contaminating UL reception, while in the UE side, the UL transmission might contaminate DL reception.

In practice, it is more feasible to realize full duplex in BS side than in UE side because more space is available in the BS side and Tx/Rx antenna branches can be separated for self-interference cancellation. Besides, more advanced receiver can be adopted in the BS side, which is fundamental for self-interference cancellation.

Therefore, one scenario is to deploy full duplex in BS side only, while half duplex is still used in the UE side. This means in a set of time slots, the BS may transmit data signal to some UEs, and receive data signal from others. In addition, non-overlapped frequency resources could be allocated for DL transmission (to some UEs) and UL reception (from other UEs) to mitigate self-interference. This kind of full duplex mode is known as subband full duplex (SBFD). From UE point of view, the UEs could be categorized to be SBFD aware UEs (i.e., aware full duplex in BS side) and SBFD non-aware UEs, depending on UE capability.

In TDD system, SBFD can be used to enhance UL performance. A UL subband could be configured in some of the DL symbols or flexible symbols so that more resources are available for UL transmission. In such symbols, UL transmissions for some UEs could be scheduled in the UL subband while DL transmission for other UEs could be scheduled in the resources out of the UL subband.

FIG. 1C illustrates an example transmission scenario related to some embodiments of the present disclosure. As shown in FIG. 1C, the transmission scenario is SBFD in TDD system, where a UL subband is configured on a set of DL symbols and a set of flexible symbols. UL transmission can be scheduled in the symbols with UL subband. In the UL slots, the UL transmission is scheduled in the active UL bandwidth parts (BWP).

In both dynamic grant (DG) and configured grant (CG) transmission, one PUSCH transmission instance is not allowed to cross the slot boundary. Therefore, to avoid transmitting a long PUSCH across slot boundary, the UE may transmit small PUSCHs in several repetitions scheduled by an UL grant or RRC in the consecutive available transmission occasions. The use of PUSCH repetitions for one transport block (TB) also reduces latency and increases reliability of PUSCH transmission where a UE can be configured to transmit a number of repetitions across consecutive transmission occasions without feedback.

In new radio (NR), PUSCH supports two repetition types: PUSCH repetition type A and PUSCH repetition type B. For PUSCH repetition type A, the same symbol allocation is applied in the repeated transmissions. For PUSCH repetition type B, same or different symbol allocation is applied in the repeated transmission.

For PUSCH repetition Type A, the PUSCH mapping type could be set to Type A or Type B. For PUSCH mapping type A, the PUSCH starting symbol is always the first OFDM symbol of the slot. For PUSCH mapping type B, the starting symbol could be any symbol of the slot.

Table 1 shows the available start symbol(s) S, the length of PUSCH symbols L, for normal cyclic prefix and extended cyclic prefix for PUSCH mapping type A and PUSCH mapping type B, respectively.

TABLE 1
Valid S and L combinations for PUSCH mapping type A and type B

| PUSCH | | | | | | |
|---|---|---|---|---|---|---|
| mapping | Normal cyclic prefix | | | Extended cyclic prefix | | |
| type | S | L | S + L | S | L | S + L |
| Type A | 0 | (4, . . . , 14} | (4, . . . , 14} | 0 | (4, . . . , 12} | {4, . . . , 12} |
| (repetition | | | | | | |
| Type A | | | | | | |
| only) | | | | | | |
| Type B | {0, . . . , 13} | {1, . . . , 14} | {1, . . . , 14} | {0, . . . , 11} | {1, . . . , 12} | {1, . . . , 12} |
| | | | for repetition | | | for repetition |
| | | | Type A, | | | Type A, |
| | | | (1, . . . , 27} | | | {1, . . . , 23} |
| | | | for repetition | | | for repetition |
| | | | Type B | | | Type B |

As shown in Table 1, for PUSCH mapping type A, the PUSCH starting symbol is always the first OFDM symbol of the slot. For PUSCH mapping type B, the starting symbol could be one of the symbols of the slot.

Besides, for PUSCH repetition type A, a signaling AvailableSlotCounting can be configured to the UE. AvailableSlotCounting indicates whether PUSCH repetitions counted on the basis of available slots is enabled. In the case that AvailableSlotCounting is configured as enabled, the UE determines that a slot is not counted in the PUSCH transmission of a PUSCH repetition type A if at least one of the symbols in the slot overlaps with a DL symbol, or a symbol of a synchronization signal and physical broadcast channel (SS/PBCH) block.

FIG. 1D illustrates an example PUSCH repetition related to some embodiments of the present disclosure. The two PUSCH repetitions are transmitted in the two consecutive and valid UL slots. FIG. 1E illustrates another example PUSCH repetition related to some embodiments of the present disclosure. The two PUSCH repetitions are transmitted in two non-consecutive slots, slot k and slot k+2, given that slot k+1 is not a valid slot for PUSCH repetition since the PUSCH allocation overlaps with DL symbols in slot k+1.

As shown in FIG. 1C, the UL subbands are configured in all the symbols of the DL slots, in some cases it can be available or configured in a subset of symbols of the slot. For example, in a slot with SSB symbols, the UL subband might not be configured or available in these symbols. As a result, a slot may consist of both seamless bidirectional forwarding detection SBFD symbols and non-SBFD symbols.

FIG. 1F illustrates example slots related to some embodiments of the present disclosure. Two cases of symbol level SBFD are identified in FIG. 1F. In case 1, a slot consists of DL symbols and SBFD symbols, and in case 2, a slot consists of SBFD symbols and UL symbols. It is noted although not illustrated in the FIG. 1F, a short transition time period might be needed for the BS (and/or UE) to transit between SBFD symbols and non-SBFD symbols for both cases.

Conventionally, for PUSCH repetition type A with mapping type A, PUSCH start symbol is always the first symbol of the slot, PUSCH repetition cannot be transmitted in the case 1 slots of FIG. 1F since there is DL symbol(s) allocated at the beginning. Besides, for PUSCH repetition type A with mapping type B, if the PUSCH start symbol is overlapped with the DL symbol, the case 1 slots cannot be used for PUSCH repetition, either. As a summary, UL subband cannot be effectively used for PUSCH repetition.

One straightforward solution is to allow PUSCH repetition to be transmitted in the case 1 slots, but the PUSCH symbols in such slots are punctured if they fall outside of the SBFD symbols. For example, for PUSCH repetition type A, the PUSCH payload is encoded and modulated based on the amount of physical resource in the UL slot, and the PUSCH could be transmitted in a case 1 slot by puncturing the modulated symbols mapped to the DL symbols.

However, in such case, DMRS symbols in this slot might be punctured as well. This hurts the channel estimation performance and furthermore hurts the PUSCH demodulation performance. Table 2 shows the relations between the DMRS positions and the scheduled PUSCH resources for PUSCH mapping type A and PUSCH mapping type B, respectively.

TABLE 2
PUSCH DMRS positions

| | DM-RS positions l̅ | | | | | | | |
|---|---|---|---|---|---|---|---|---|
| | PUSCH mapping type A | | | | PUSCH mapping type B | | | |
| l_{d} in | dmrs-AdditionalPosition | | | | dmrs-AdditionalPosition | | | |
| symbols | pos0 | pos1 | pos2 | pos3 | pos0 | pos1 | pos2 | pos3 |
| <4 | — | — | — | — | l₀ | l₀ | l₀ | l₀ |
| 4 | l₀ | l₀ | l₀ | l₀ | l₀ | l₀ | l₀ | l₀ |
| 5 | l₀ | l₀ | l₀ | l₀ | l₀ | l₀, 4 | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀ | l₀, 6 | l₀, 3, 6 | l₀, 3, 6 |
| 9 | l₀ | l₀, 7 | l₀, 7 | l₀, 7 | l₀ | l₀, 6 | l₀, 3, 6 | l₀, 3, 6 |
| 10 | l₀ | l₀, 9 | l₀, 6, 9 | l₀, 6, 9 | l₀ | l₀, 8 | l₀, 4, 8 | l₀, 3, 6, 9 |
| 11 | l₀ | l₀, 9 | l₀, 6, 9 | l₀, 6, 9 | l₀ | l₀, 8 | l₀, 4, 8 | l₀, 3, 6, 9 |
| 12 | l₀ | l₀, 9 | l₀, 6, 9 | l₀, 5, 8, 11 | l₀ | l₀, 10 | l₀, 5, 10 | l₀, 3, 6, 9 |
| 13 | l₀ | l₀, 11 | l₀, 7, 11 | l₀, 5, 8, 11 | l₀ | l₀, 10 | l₀, 5, 10 | l₀, 3, 6, 9 |
| 14 | l₀ | l₀, 11 | l₀, 7, 11 | l₀, 5, 8, 11 | l₀ | l₀, 10 | l₀, 5, 10 | l₀, 3, 6, 9 |

For example, based on the specified Table 2 for determination of DMRS symbols, it can be observed that for case 1 slot, dmrs-additionalPosition is set to be pos0, which means there is no additional DMRS symbols, and DMRS position, which is configured by dmrs-TypeA-Position and indicated by l₀, is configured as either the second or the third symbol. The value of l_{d} represents the duration between the first orthogonal frequency division multiplexing (OFDM) symbol of the slot and the last OFDM symbol of the scheduled PUSCH resources in the slot. However, if the DMRS symbol is overlap with a DL symbol in the case 1 slot, the DMRS symbol will be punctured.

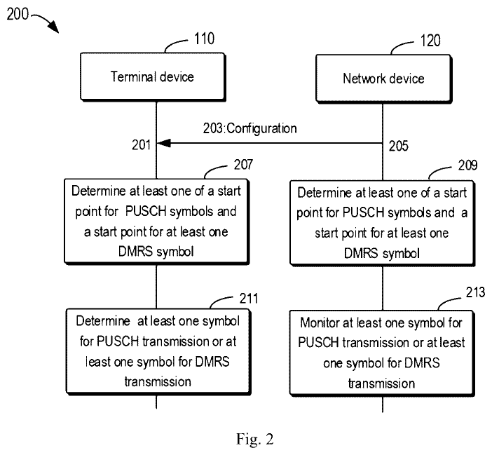

In view of the above discussions, embodiments of the present disclosure provide a solution for PUSCH and DMRS transmission. In one aspect of the solution of the present disclosure, a terminal device receives, via the transceiver from a network device, a configuration for PUSCH repetitions and a DMRS. The terminal device determines, based on the configuration, a start point for PUSCH symbols, a start point for at least one DMRS symbol in a DL slot with SBFD symbols, or a combination of the above-mentioned items. Based on the start point for the PUSCH symbols, the start point for the at least one DMRS symbol or a combination of the above-mentioned items, the terminal device determines at least one symbol for PUSCH transmission and at least one symbol for DMRS transmission in the DL slot with the SBFD symbols via the transceiver. In this way, PUSCH transmission latency is reduced and UL subband utilization efficiency is improved. Thereby the performance of communications is improved. Principles and implementations of embodiments of the present disclosure will be described in detail below with reference to FIGS. 2-10.

### Example Method

FIG. 2 illustrates an example signaling chart illustrating an example process 200 according to some embodiments of the present disclosure. For the purpose of discussion, the example 200 will be described with reference to FIG. 1A.

In the example process 200, a terminal device 110 receives 201 a configuration 203 for PUSCH repetitions and a DMRS from a network device 120. Correspondingly, the network device 120 transmits 205 the configuration 203 to the terminal device 110.

In some embodiments, the configuration 203 may comprise a first indication of whether PUSCH repetitions counted on the basis of available slots is enabled. In some embodiments, the configuration may comprise a second indication of whether to use additional DMRS symbols. In some embodiments, the configuration may comprise a third indication of the start symbol index for DMRS transmission. In some embodiments, the configuration may comprise the first indication of whether PUSCH repetitions counted on the basis of available slots is enabled and the second indication of whether to use additional DMRS symbols. In some embodiments, the configuration may comprise the first indication of whether PUSCH repetitions counted on the basis of available slots is enabled and the third indication of the start symbol index for DMRS transmission. In some embodiments, the configuration may comprise the second indication of whether to use additional DMRS symbols and the third indication of the start symbol index for DMRS transmission. In some embodiments, the configuration may comprise the first indication of whether PUSCH repetitions counted on the basis of available slots is enabled, the second indication of whether to use additional DMRS symbols and the third indication of the start symbol index for DMRS transmission.

In some embodiments, a case 1 slot is always available and counted for PUSCH repetition no matter whether PUSCH repetitions counted on the basis of available slots (i.e., indicated by AvailableSlotCounting) is enabled or not enabled.

In some embodiments, a case 1 slot is available and counted for PUSCH repetition when PUSCH repetitions counted on the basis of available slots is enabled and is not available and counted for PUSCH repetition when PUSCH repetitions counted on the basis of available slots is not enabled.

Continuing with reference to FIG. 2, based on the configuration 203, the terminal device 110 determines 207 a start point for the PUSCH symbols, a start point for the at least one DMRS symbol in a DL slot with SBFD symbols, or a combination of the above-mentioned items. For example, the start point may be a reference point for PUSCH or DMRS. In order to allow PUSCH repetition in the case 1 slots while keep DMRS symbol(s) available for channel estimation purpose, for PUSCH repetition type A with mapping type A and PUSCH repeated in a case 1 slot, the start point for PUSCH time domain allocation and/or DMRS symbols allocation may be revised from the start of the slot to be the start of the configured SBFD symbols.

In some embodiments, in order to determine the start point for the PUSCH symbols, the start point for at least one DMRS symbol, or a combination of the above-mentioned items, the terminal device 110 may determine a start of the DL slot as the start point for the PUSCH symbols, a start of the SBFD symbols as the start point for the at least one DMRS symbol, or a combination of the above-mentioned items. For example, the PUSCH allocation follows legacy with the start point being the start of the slot, while DMRS allocation is based on the new start point. The PUSCH symbols outside of the SBFD symbols (i.e., overlapped with the DL symbols) are punctured. The PUSCH symbols inside the SBFD symbols are used for PUSCH transmission.

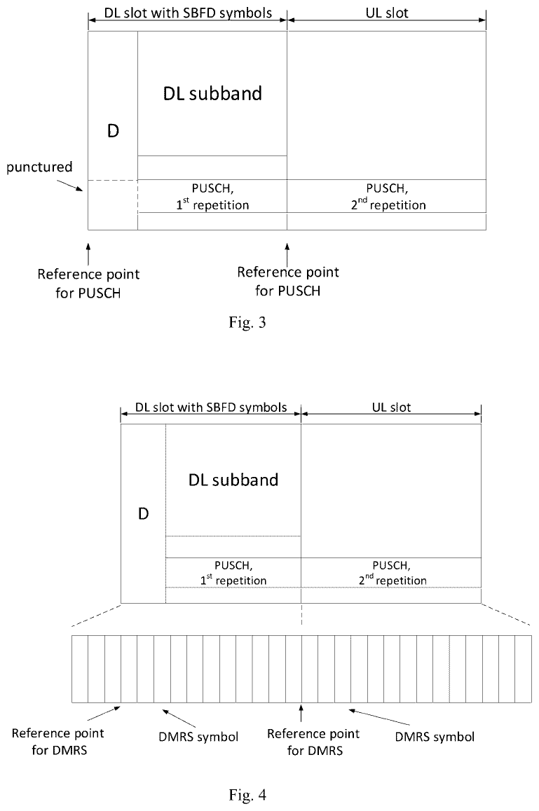

FIG. 3 illustrates an example PUSCH resource allocation according to some embodiments of the present disclosure. As shown in FIG. 3, there are DL slot with SBFD symbols (i.e. case 1 slot) and UL slot, and the PUSCH is repeated in the two slots. The PUSCH in a case 1 slot is mapped to the physical resources by using the start of the slot as the reference, and the PUSCH symbols outside of the SBFD symbols are punctured. FIG. 4 illustrates an example PUSCH and DMRS resource allocation according to some embodiments of the present disclosure. As shown in FIG. 4, DMRS allocation is based on a new start point, which is the start of the SBFD symbols. The second SBFD symbol is the DMRS symbol in case 1 slot, while the second UL symbol is the DMRS symbol in the UL slot.

In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start of the DL slot as the start point for the at least one DMRS symbol, or a combination of the above-mentioned items, in the case that at least one of the at least one DMRS symbol is within the SBFD symbols. For example, PUSCH allocation is based on a new start point, while the DMRS allocation is based on legacy start point. This is applicable for the cases when at least one DMRS symbol is not punctured based on legacy start point. For PUSCH, if the allocated number of PUSCH symbols is less than the SBFD symbols, no PUSCH symbols will be punctured. Otherwise, the PUSCH symbols are mapped from the new start position until the end of SBFD symbols and the rest PUSCH modulated symbols are punctured.

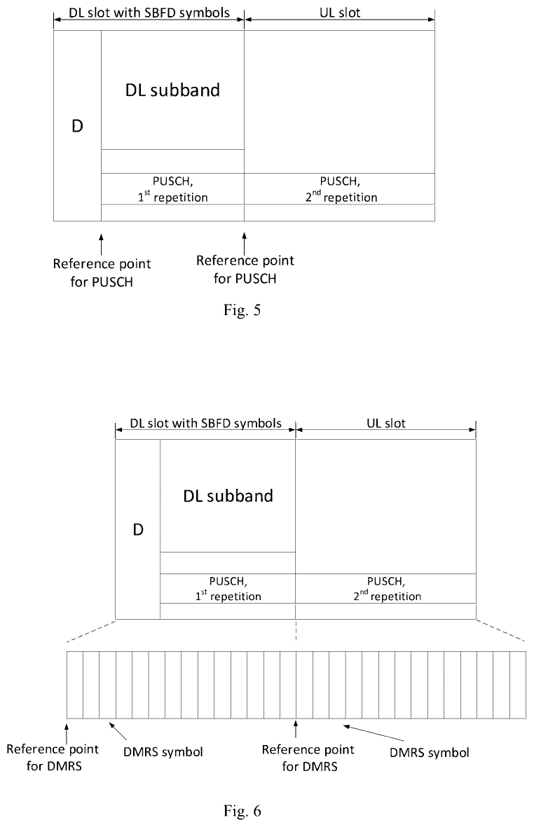

FIG. 5 illustrates another example PUSCH resource allocation according to some embodiments of the present disclosure. As shown in FIG. 5, the start point for PUSCH repetition in the case 1 slot is the start of the SBFD symbols. The PUSCH is mapped to the physical resource from the beginning of the SBFD symbols until the last SBFD symbol, and the rest modulated PUSCH symbols are punctured. FIG. 6 illustrates another example PUSCH and DMRS resource allocation according to some embodiments of the present disclosure. As shown in FIG. 6, the start point for DMRS allocation is the start of the slot for both case 1 slot and the UL slot. DMRS symbol in the case 1 slot is not punctured.

In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start point for the at least one DMRS symbol, or a combination of the above-mentioned items. For example, both PUSCH allocation and DMRS allocation are based on the new start point, as shown in FIG. 4 and FIG. 5.

In some embodiments, in order to determine the start point for the PUSCH symbols, the start point for at least one DMRS symbol, or a combination of the above-mentioned items, the terminal device 110 may determine a start of the PUSCH symbols as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start of the PUSCH symbols as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start point for the at least one DMRS symbol, or a combination of the above-mentioned items.

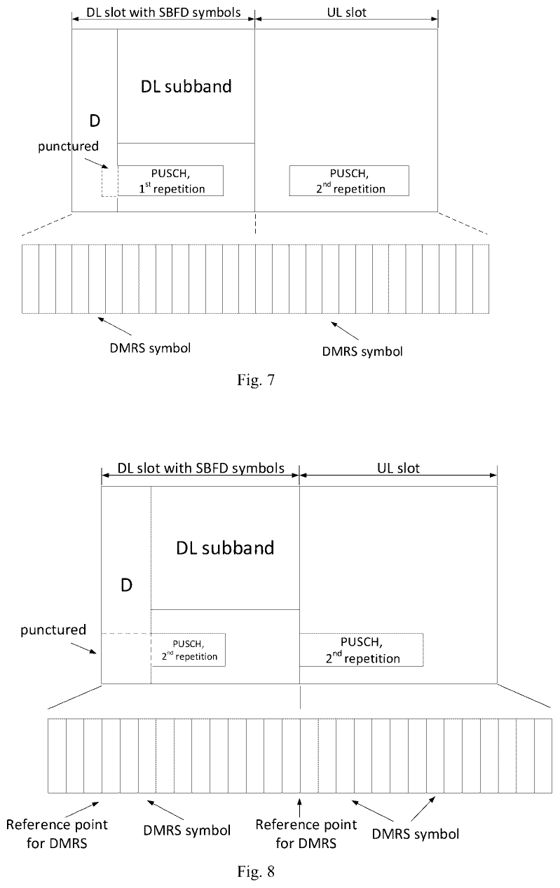

For example, for PUSCH repetition type A in case 1 slots with mapping type B, the start point for PUSCH time domain resource allocation and DMRS allocation depends on whether the PUSCH symbols are within the SBFD symbols. FIG. 7 illustrates an example PUSCH and DMRS resource allocation according to some embodiments of the present disclosure. As shown in FIG. 7, the PUSCH mapping type is type B, the start symbol may be a DL symbol in the case 1 slot, the start point for PUSCH or DMRS may be a start of the PUSCH symbols or the start of the SBFD symbols.

Referring back to FIG. 2, the network device 120 determines 209 a start point for PUSCH symbols, a start point for at least one DMRS symbol, or a combination of the above-mentioned items in a DL slot with SBFD symbols.

In some embodiments, in order to determine the start point for the PUSCH symbols, the start point for at least one DMRS symbol, or a combination of the above-mentioned items, the network device 120 may determine a start of the DL slot as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start of the DL slot as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start point for the at least one DMRS symbol, or a combination of the above-mentioned items.

In some embodiments, in order to determine the start point for the PUSCH symbols, the start point for at least one DMRS symbol, or a combination of the above-mentioned items, the network device 120 may determine a start of the PUSCH symbols as the start point for the PUSCH symbols, a start of the SBFD symbols as the start point for the at least one DMRS symbol, or a combination of the above-mentioned items.

In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start of the PUSCH symbols as the start point for the at least one DMRS symbol, or a combination of the above-mentioned items, in the case that at least one of the at least one DMRS symbol is within the SBFD symbols.

In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start point for the at least one DMRS symbol, or a combination of the above-mentioned items.

Continuing with reference to FIG. 2, the terminal device 110 determines 211 at least one symbol for PUSCH transmission and at least one symbol for DMRS transmission in the DL slot with the SBFD symbols via the transceiver based on the start point for the PUSCH symbols, the start point for the at least one DMRS symbol, or a combination of the above-mentioned items.

In some embodiments, in order to determine the at least one symbol for the DMRS transmission, the terminal device 110 may determine a resource allocation of the at least one DMRS symbol based on a duration of PUSCH symbols within the SBFD symbols. For example, some of the PUSCH symbols or DMRS symbols may be punctured. For the number of PUSCH symbols (i.e., l_{d} in Table 2) for determining DMRS symbols in case 1 slots, l_{d} should be revised to be the duration of the PUSCH symbols within the SBFD symbols.

In some embodiments, the duration may be from the first symbol of the SBFD symbols to a last symbol of the PUSCH symbols in the case that a number of the PUSCH symbols is smaller than a number of SBFD symbols. For example, l_{d} in the UL slot (or the scheduled number of PUSCH symbols) is smaller than the number of SBFD symbols, then l_{d} in case 1 slot is revised to the duration between the first OFDM symbol of the SBFD symbols to the last symbol of PUSCH. FIG. 8 illustrates another example PUSCH and DMRS resource allocation according to some embodiments of the present disclosure. As shown in FIG. 8, l_{d} in the UL slot is equal to 8, while l_{d} in the case 1 slot is equal to 5. The DMRS position in the UL slot should follow the configuration in Table 2 with l_{d}=8. Therefore, two OFDM symbols are taken as DMRS symbols with dmrs-AdditionalPosition=pos1, while the DMRS position in UL slot should follow the configuration in Table 2 with l_{d}=5. As a result, only 1 OFDM symbol is taken as DMRS symbol with dmrs-AdditionalPosition=pos1.

In some embodiments, the duration may be from the first symbol of the SBFD symbols to the last symbol of the SBFD symbols in the case that the number of the PUSCH symbols is larger than the number of SBFD symbols. For example, l_{d} in the UL slot (or the scheduled number of PUSCH symbols) is larger than the number of SBFD symbols, then l_{d} in the case 1 slot is revised to the duration between the first OFDM symbol of the SBFD symbols to the last symbol of SBFD symbols. As shown in FIG. 4, PUSCH occupying all the UL symbols in the UL slot, and l_{d} is equal to 14. The first 3 symbols allocated as DL in the case 1 slot, and l_{d} in the case 1 slot is equal to 11. The DMRS position in the UL slot should follow the configuration in Table 2 with l_{d}=¹⁴, while the DMRS position in UL slot should follow the configuration in Table 2 with l_{d}=¹¹.

In some embodiments, the duration may be from a first symbol of the PUSCH symbols to the last symbol of the PUSCH symbols in the case that the PUSCH symbols are within the number of SBFD symbols. In some embodiments, the first symbol of the PUSCH symbols may be a DMRS symbol in the case that the PUSCH symbols are within the number of SBFD symbols.

For example, if the PUSCH symbols are within the SBFD symbols, the DMRS allocation follows the legacy, i.e., l_{d} is the duration of PUSCH resources. l₀=0, i.e., the first PUSCH symbol is the first DMRS symbol.

In some embodiments, the duration may be from a first symbol of the PUSCH symbols to a last symbol of the PUSCH symbols within the SBFD symbols in the case that at least one of the PUSCH symbols is outside of the SBFD symbols. In some embodiments, the first symbol of the SBFD symbols may be the DMRS symbol in the case that at least one of the PUSCH symbols is outside of the SBFD symbols. For example, l_{d} is the duration of PUSCH symbols within the SBFD symbols. l₀ is the first SBFD symbol, i.e., the first SBFD symbol is the first DMRS symbol.

Referring back to FIG. 2, the network device 120 monitors 213 at least one symbol for PUSCH transmission and at least one symbol for DMRS transmission in the DL slot with the SBFD symbols based on the start point for the PUSCH symbols, the start point for the at least one DMRS symbol, or a combination of the above-mentioned items.

In some embodiments, in order to monitor at least one symbol for the DMRS transmission, the network device 120 may determine a resource allocation of the at least one DMRS symbol based on a duration of PUSCH symbols within the SBFD symbols.

In some embodiments, the network device 120 may further transmit a configuration to the terminal device 110. The configuration indicates a start point for the PUSCH symbols, a start point for the at least one DMRS symbol, or a combination of the above-mentioned items. In some embodiments, the start point for the PUSCH symbols or the start point for the at least one DMRS symbol may be a DL symbol or a SBFD symbol. Correspondingly, the terminal device 110 may receive the configuration from the network device 120. Based on the configuration, the terminal device 110 may determine the start point for the PUSCH symbols, the start point for the at least one DMRS symbol, or a combination of the above-mentioned items. Alternatively, for the start point determination, the start point for PUSCH resource allocation or for DMRS symbol(s) determination in a case 1 slot could be configured by the base station. For example, it could be configured to be a start of an indicated DL symbol or an SBFD symbol in the case 1 slot.

In some embodiments, a resource allocation of the PUSCH symbols may be indicated on top of an UL slot that is involved in the PUSCH repetitions. In some embodiments, the terminal device 110 may further preserve the PUSCH symbols in the case that the PUSCH symbols are within the SBFD symbols. In some embodiments, the terminal device 110 may puncture at least one of the PUSCH symbols outside of the SBFD symbols in the case that the at least one of the PUSCH symbols is outside of the SBFD symbols.

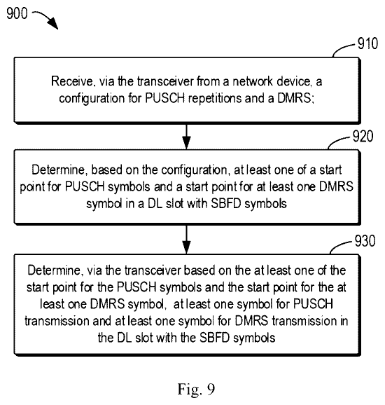

FIG. 9 illustrates a flowchart of a method implemented at a terminal device according to some embodiments of the present disclosure. In some embodiments, the method 900 can be implemented at a communication device, such as the terminal device 110 as shown in FIG. 1A. In some other embodiments, the method 900 may be implemented at devices not shown in FIG. 1A. Further, it is to be understood that the method 900 may include additional blocks not shown and/or may omit some blocks as shown, and the scope of the present disclosure is not limited in this regard. For the purpose of discussion, the method 900 will be described from the perspective of the terminal device 110 with reference to FIG. 1A.

At block 910, the terminal device 110 receives a configuration for PUSCH repetitions and a DMRS via the transceiver from a network device. At block 920, the terminal device 110 determines a start point for PUSCH symbols, a start point for at least one DMRS symbol, or a combination of the above-mentioned items in a DL slot with SBFD symbols based on the configuration. At block 930, based on the start point for the PUSCH symbols, the start point for the at least one DMRS symbol, or a combination of the above-mentioned items, the terminal device 110 determines at least one symbol for PUSCH transmission and at least one symbol for DMRS transmission in the DL slot with the SBFD symbols via the transceiver.

In some embodiments, the configuration may comprise a first indication of whether PUSCH repetitions counted on the basis of available slots is enabled, a second indication of whether to use additional DMRS symbols, a third indication of the start symbol index for DMRS transmission, or any combination of two or more of the above-mentioned items. In some embodiments, a resource allocation of the PUSCH symbols may be indicated on top of an UL slot that is involved in the PUSCH repetitions.

In some embodiments, in order to determine the start point for the PUSCH symbols, the start point for at least one DMRS symbol, or a combination of the above-mentioned items, the terminal device 110 may determine a start of the DL slot as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start of the DL slot as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start point for the at least one DMRS symbol, or a combination of the above-mentioned items.

In some embodiments, in order to determine the start point for the PUSCH symbols, the start point for at least one DMRS symbol, or a combination of the above-mentioned items, the terminal device 110 may determine a start of the PUSCH symbols as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start of the PUSCH symbols as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the terminal device 110 may determine the start of the SBFD symbols as the start point for the PUSCH symbols, the start point for the at least one DMRS symbol, or a combination of the above-mentioned items.

In some embodiments, in order to determine the at least one symbol for the DMRS transmission, the terminal device 110 may determine a resource allocation of the at least one DMRS symbol based on a duration of PUSCH symbols within the SBFD symbols.

In some embodiments, the duration may from a first symbol of the SBFD symbols to a last symbol of the PUSCH symbols in the case that a number of the PUSCH symbols is smaller than a number of SBFD symbols. In some embodiments, the duration may be from the first symbol of the SBFD symbols to the last symbol of the SBFD symbols in the case that the number of the PUSCH symbols is larger than the number of SBFD symbols.

In some embodiments, the duration may be from a first symbol of the PUSCH symbols to the last symbol of the PUSCH symbols in the case that the PUSCH symbols are within the number of SBFD symbols. In some embodiments, the duration may be from a first symbol of the PUSCH symbols to a last symbol of the PUSCH symbols within the SBFD symbols in the case that at least one of the PUSCH symbols is outside of the SBFD symbols.

In some embodiments, the first symbol of the PUSCH symbols may be a DMRS symbol in the case that the PUSCH symbols are within the number of SBFD symbol. In some embodiments, the first symbol of the SBFD symbols may be the DMRS symbol in the case that at least one of the PUSCH symbols is outside of the SBFD symbols.

In some embodiments, the terminal device 110 may further receive a configuration via the transceiver from a network device. The configuration indicates a start point for the PUSCH symbols, a start point for the at least one DMRS symbol, or a combination of the above-mentioned items. Based on the configuration, the terminal device 110 may determine the start point for the PUSCH symbols, the start point for the at least one DMRS symbol, or a combination of the above-mentioned items. In some embodiments, the start point for the PUSCH symbols or the start point for the at least one DMRS symbol may be a DL symbol or a SBFD symbol.

In some embodiments, the terminal device 110 may further preserve the PUSCH symbols in the case that the PUSCH symbols are within the SBFD symbols. In some embodiments, the terminal device 110 may puncture at least one of the PUSCH symbols outside of the SBFD symbols in the case that the at least one of the PUSCH symbols is outside of the SBFD symbols.

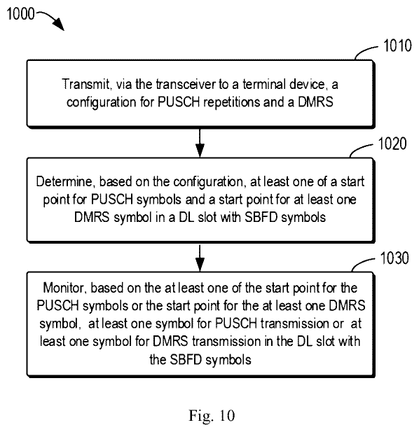

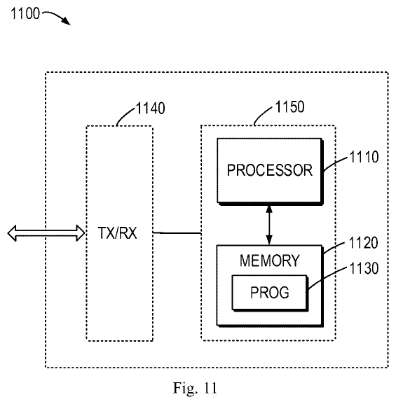

FIG. 10 illustrates a flowchart of a method implemented at a network device according to some embodiments of the present disclosure. In some embodiments, the method 1000 can be implemented at a communication device, such as the network device 120 as shown in FIG. 1A. In some other embodiments, the method 1000 may be implemented at devices not shown in FIG. 1A. Further, it is to be understood that the method 1000 may include additional blocks not shown and/or may omit some blocks as shown, and the scope of the present disclosure is not limited in this regard. For the purpose of discussion, the method 1000 will be described from the perspective of the network device 120 with reference to FIG. 1A.

At block 1010, the network device 120 transmits a configuration for PUSCH repetitions and a DMRS via the transceiver to a terminal device. At block 1020, based on the configuration, the network device 120 determines a start point for PUSCH symbols, a start point for at least one DMRS symbol, or a combination of the above-mentioned items in a DL slot with SBFD symbols. At block 1030, based on the start point for the PUSCH symbols, the start point for the at least one DMRS symbol, or a combination of the above-mentioned items, the network device 120 monitors at least one symbol for PUSCH transmission and at least one symbol for DMRS transmission in the DL slot with the SBFD symbols.

In some embodiments, the configuration may comprise a first indication of whether PUSCH repetitions counted on the basis of available slots is enabled, a second indication of whether to use additional DMRS symbols, a third indication of the start symbol index for DMRS transmission, or any combination of two or more of the above-mentioned items. In some embodiments, a resource allocation of the PUSCH symbols may be indicated on top of an UL slot that is involved in the PUSCH repetitions.

In some embodiments, in order to determine the start point for the PUSCH symbols, the start point for at least one DMRS symbol, or a combination of the above-mentioned items, the network device 120 may determine a start of the DL slot as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start of the DL slot as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start point for the at least one DMRS symbol, or a combination of the above-mentioned items.

In some embodiments, in order to determine the start point for the PUSCH symbols, the start point for at least one DMRS symbol, or a combination of the above-mentioned items, the network device 120 may determine a start of the PUSCH symbols as the start point for the PUSCH symbols, a start of the SBFD symbols as the start point for the at least one DMRS symbol, or a combination of the above-mentioned items. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start of the PUSCH symbols as the start point for the at least one DMRS symbol, or a combination of the above-mentioned items, in the case that at least one of the at least one DMRS symbol is within the SBFD symbols. In some embodiments, in order to determine the start point for the PUSCH symbols, the start point for at least one DMRS symbol, or a combination of the above-mentioned items, the network device 120 may determine the start of the SBFD symbols as the start point for the PUSCH symbols, the start point for the at least one DMRS symbol, or a combination of the above-mentioned items.

In some embodiments, in order to monitor at least one symbol for the DMRS transmission, the network device 120 may determine a resource allocation of the at least one DMRS symbol based on a duration of PUSCH symbols within the SBFD symbols.

In some embodiments, the duration may be from a first symbol of the SBFD symbols to a last symbol of the PUSCH symbols in the case that a number of the PUSCH symbols is smaller than a number of SBFD symbols, or the duration may be from the first symbol of the SBFD symbols to the last symbol of the SBFD symbols in the case that the number of the PUSCH symbols is larger than the number of SBFD symbols.

In some embodiments, the duration may be from a first symbol of the PUSCH symbols to the last symbol of the PUSCH symbols in the case that the PUSCH symbols are within the number of SBFD symbols, or the duration may be from a first symbol of the PUSCH symbols to a last symbol of the PUSCH symbols within the SBFD symbols in the case that at least one of the PUSCH symbols is outside of the SBFD symbols.

In some embodiments, the first symbol of the PUSCH symbols may be a DMRS symbol in the case that the PUSCH symbols are within the number of SBFD symbols, or the first symbol of the SBFD symbols may be the DMRS symbol in the case that at least one of the PUSCH symbols is outside of the SBFD symbols.

In some embodiments, the network device 120 may further transmit a configuration to the terminal device via the transceiver. The configuration indicates a start point for the PUSCH symbols, a start point for the at least one DMRS symbol, or a combination of the above-mentioned items. In some embodiments, the start point for the PUSCH symbols or the start point for the at least one DMRS symbol is a DL symbol or a SBFD symbol.

In this way, new start point is determined for PUSCH allocation and DMRS allocation for PUSCH repetition type A with mapping type A and mapping type B. New l_{d} definition is determined for determining DMRS symbols. UL subband for PUSCH repetition type A is effectively used. Thereby the PUSCH transmission latency is reduced and UL subband utilization efficiency is improved.

### Example Apparatus

FIG. 11 illustrates a simplified block diagram of a device 1100 that is suitable for implementing embodiments of the present disclosure. The device 1000 can be considered as a further example implementation of the terminal device 110, and the network device 120 as shown in FIG. 1A. Accordingly, the device 1000 can be implemented at or as at least a part of the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 1130 is assumed to include program instructions that, when executed by the associated processor 1110, enable the device 1100 to operate in accordance with the embodiments of the present disclosure, as discussed herein with reference to FIGS. 1-10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.

Clause 1. A terminal device comprising: a processor; and a transceiver coupled to the processor, wherein the processor is configured to: receive, via the transceiver from a network device, a configuration for physical uplink shared channel (PUSCH) repetitions and a demodulation reference signal (DMRS); determine, based on the configuration, at least one of a start point for PUSCH symbols or a start point for at least one DMRS symbol in a downlink (DL) slot with subband full duplex (SBFD) symbols; and determine, via the transceiver based on the at least one of the start point for the PUSCH symbols or the start point for the at least one DMRS symbol, at least one symbol for PUSCH transmission and at least one symbol for DMRS transmission in the DL slot with the SBFD symbols.

Clause 2. The terminal device of clause 1, wherein determining at least one of the start point for the PUSCH symbols or the start point for the at least one DMRS symbol comprises one of the following: determining at least one of a start of the DL slot as the start point for the PUSCH symbols or a start of the SBFD symbols as the start point for the at least one DMRS symbol; determining at least one of the start of the SBFD symbols as the start point for the PUSCH symbols or the start of the DL slot as the start point for the at least one DMRS symbol in the case that at least one of the at least one DMRS symbol is within the SBFD symbols; or determining the start of the SBFD symbols as at least one of the start point for the PUSCH symbols or the start point for the at least one DMRS symbol.

Clause 3. The terminal device of clause 1, wherein determine at least one of the start point for the PUSCH symbols or the start point for the at least one DMRS symbol comprises one the following: determining at least one of a start of the PUSCH symbols as the start point for the PUSCH symbols or a start of the SBFD symbols as the start point for the at least one DMRS symbol; determining at least one of the start of the SBFD symbols as the start point for the PUSCH symbols or the start of the PUSCH symbols as the start point for the at least one DMRS symbol in the case that at least one of the at least one DMRS symbol is within the SBFD symbols; or determining at least one of the start of the SBFD symbols as the start point for the PUSCH symbols or the start point for the at least one DMRS symbol.

Clause 4. The terminal device of clause 1, wherein determining the at least one symbol for the DMRS transmission comprises: determining a resource allocation of the at least one DMRS symbol based on a duration of PUSCH symbols within the SBFD symbols.

Clause 5. The terminal device of clause 4, wherein one of the following: the duration is from a first symbol of the SBFD symbols to a last symbol of the PUSCH symbols in the case that a number of the PUSCH symbols is smaller than a number of SBFD symbols; or the duration is from the first symbol of the SBFD symbols to the last symbol of the SBFD symbols in the case that the number of the PUSCH symbols is larger than the number of SBFD symbols.

Clause 6. The terminal device of clause 4, wherein one of the following: the duration is from a first symbol of the PUSCH symbols to the last symbol of the PUSCH symbols in the case that the PUSCH symbols are within the number of SBFD symbols; or the duration is from a first symbol of the PUSCH symbols to a last symbol of the PUSCH symbols within the SBFD symbols in the case that at least one of the PUSCH symbols is outside of the SBFD symbols.

Clause 7. The terminal device of clause 6, wherein one of the following: the first symbol of the PUSCH symbols is a DMRS symbol in the case that the PUSCH symbols are within the number of SBFD symbols; or the first symbol of the SBFD symbols is the DMRS symbol in the case that at least one of the PUSCH symbols is outside of the SBFD symbols.

Clause 8. The terminal device of clause 1, wherein the processor is further configured to: receive, via the transceiver from a network device, a configuration indicating at least one of a start point for the PUSCH symbols or a start point for the at least one DMRS symbol; and determine, based on the configuration, at least one of the start point for the PUSCH symbols or the start point for the at least one DMRS symbol.

Clause 9. The terminal device of clause 8, wherein the start point for the PUSCH symbols or the start point for the at least one DMRS symbol is a DL symbol or a SBFD symbol.

Clause 10. The terminal device of clause 1, wherein the configuration comprises at least one of the following: a first indication of whether PUSCH repetitions counted on the basis of available slots is enabled; a second indication of whether to use additional DMRS symbols; or a third indication of the start symbol index for DMRS transmission.

Clause 11. The terminal device of clause 1, wherein a resource allocation of the PUSCH symbols is indicated on top of an uplink (UL) slot that is involved in the PUSCH repetitions.

Clause 12. The terminal device of any of clauses 1-11, wherein the processor is further configured to: preserve the PUSCH symbols in the case that the PUSCH symbols are within the SBFD symbols; and puncture at least one of the PUSCH symbols outside of the SBFD symbols in the case that the at least one of the PUSCH symbols is outside of the SBFD symbols.

Clause 13. A network device comprising: a processor; and a transceiver coupled to the processor, wherein the processor is configured to: transmit, via the transceiver to a terminal device, a configuration for physical uplink shared channel (PUSCH) repetitions and a demodulation reference signal (DMRS); determine, based on the configuration, at least one of a start point for PUSCH symbols or a start point for at least one DMRS symbol in a downlink (DL) slot with subband full duplex (SBFD) symbols; and monitor, based on the at least one of the start point for the PUSCH symbols or the start point for the at least one DMRS symbol, at least one symbol for PUSCH transmission and at least one symbol for DMRS transmission in the DL slot with the SBFD symbols.

Clause 14. The network device of clause 13, wherein determining at least one of the start point for the PUSCH symbols or the start point for at least one DMRS symbol comprises one of the following: determining at least one of a start of the DL slot as the start point for the PUSCH symbols or a start of the SBFD symbols as the start point for the at least one DMRS symbol; determining at least one of the start of the SBFD symbols as the start point for the PUSCH symbols or the start of the DL slot as the start point for the at least one DMRS symbol in the case that at least one of the at least one DMRS symbol is within the SBFD symbols; or determining at least one of the start of the SBFD symbols as the start point for the PUSCH symbols or the start point for the at least one DMRS symbol.

Clause 15. The network device of clause 13, wherein determine at least one of the start point for the PUSCH symbols or the start point for the at least one DMRS symbol comprises one the following: determining at least one of a start of the PUSCH symbols as the start point for the PUSCH symbols or a start of the SBFD symbols as the start point for the at least one DMRS symbol; determining at least one of the start of the SBFD symbols as the start point for the PUSCH symbols or the start of the PUSCH symbols as the start point for the at least one DMRS symbol in the case that at least one of the at least one DMRS symbol is within the SBFD symbols; or determining at least one of the start of the SBFD symbols as the start point for the PUSCH symbols or the start point for the at least one DMRS symbol.

Clause 16. The network device of clause 13, wherein monitoring the at least one symbol for the DMRS transmission comprises: determining a resource allocation of the at least one DMRS symbol based on a duration of PUSCH symbols within the SBFD symbols.

Clause 17. The network device of clause 16, wherein one of the following: the duration is from a first symbol of the SBFD symbols to a last symbol of the PUSCH symbols in the case that a number of the PUSCH symbols is smaller than a number of SBFD symbols; or the duration is from the first symbol of the SBFD symbols to the last symbol of the SBFD symbols in the case that the number of the PUSCH symbols is larger than the number of SBFD symbols.

Clause 18. The network device of clause 16, wherein one of the following: the duration is from a first symbol of the PUSCH symbols to the last symbol of the PUSCH symbols in the case that the PUSCH symbols are within the number of SBFD symbols; or the duration is from a first symbol of the PUSCH symbols to a last symbol of the PUSCH symbols within the SBFD symbols in the case that at least one of the PUSCH symbols is outside of the SBFD symbols.

Clause 19. The network device of clause 18, wherein one of the following: the first symbol of the PUSCH symbols is a DMRS symbol in the case that the PUSCH symbols are within the number of SBFD symbols; or the first symbol of the SBFD symbols is the DMRS symbol in the case that at least one of the PUSCH symbols is outside of the SBFD symbols.

Clause 20. The network device of clause 13, wherein the processor is further configured to: transmit, via the transceiver to the terminal device, a configuration indicating at least one of a start point for the PUSCH symbols or a start point for the at least one DMRS symbol.

Clause 21. The network device of clause 20, wherein the start point for the PUSCH symbols or the start point for the at least one DMRS symbol is a DL symbol or a SBFD symbol.

Clause 22. The network device of clause 13, wherein the configuration comprises at least one of the following: a first indication of whether PUSCH repetitions counted on the basis of available slots is enabled; a second indication of whether to use additional DMRS symbols; or a third indication of the start symbol index for DMRS transmission.

Clause 23. The network device of any of clauses 13-22, wherein a resource allocation of the PUSCH symbols is indicated on top of an uplink (UL) slot that is involved in the PUSCH repetitions.

Clause 24. A method performed by a terminal device, comprising: receiving, via the transceiver from a network device, a configuration for physical uplink shared channel (PUSCH) repetitions and a demodulation reference signal (DMRS); determining, based on the configuration, at least one of a start point for PUSCH symbols or a start point for at least one DMRS symbol in a downlink (DL) slot with subband full duplex (SBFD) symbols; and determining, via the transceiver based on the at least one of the start point for the PUSCH symbols or the start point for the at least one DMRS symbol, at least one symbol for PUSCH transmission and at least one symbol for DMRS transmission in the DL slot with the SBFD symbols.

Clause 25. A method performed by a network device, comprising: transmitting, via the transceiver to a terminal device, a configuration for physical uplink shared channel (PUSCH) repetitions and a demodulation reference signal (DMRS); determining, based on the configuration, at least one of a start point for PUSCH symbols or a start point for at least one DMRS symbol in a downlink (DL) slot with subband full duplex (SBFD) symbols; and; monitoring, based on the at least one of the start point for the PUSCH symbols or the start point for the at least one DMRS symbol, at least one symbol for PUSCH transmission and at least one symbol for DMRS transmission in the DL slot with the SBFD symbols.

Clause 26. A computer readable medium having instructions stored thereon, the instructions, when executed by a processor of an apparatus, causing the apparatus to perform at least the method of clause 24 or 25.

1. A terminal device for wireless communication, comprising:
at least one memory; and
at least one processor coupled with the at least one memory and operable to cause the terminal device, to:
receive a first configuration for physical uplink shared channel (PUSCH) repetitions and a demodulation reference signal (DMRS);
determine, based on the first configuration, at least one of a start point for PUSCH symbols or a start point for at least one DMRS symbol in a downlink (DL) slot with subband full duplex (SBFD) symbols; and
determine, based on the at least one of the start point for the PUSCH symbols or the start point for the at least one DMRS symbol, at least one symbol for PUSCH transmission and at least one symbol for DMRS transmission in the DL slot with the SBFD symbols.

2. The terminal device of claim 1, wherein, to determine the at least one of the start point for the PUSCH symbols or the start point for the at least one DMRS symbol, the at least one processor is operable to cause the terminal device to one of:
determine at least one of a start of the DL slot as the start point for the PUSCH symbols or a start of the SBFD symbols as the start point for the at least one DMRS symbol;
determine at least one of the start of the SBFD symbols as the start point for the PUSCH symbols or the start of the DL slot as the start point for the at least one DMRS symbol if the at least one DMRS symbol is within the SBFD symbols; or
determine the start of the SBFD symbols as at least one of the start point for the PUSCH symbols or the start point for the at least one DMRS symbol.

3. The terminal device of claim 1, wherein to determine the at least one of the start point for the PUSCH symbols or the start point for the at least one DMRS symbol, the at least one processor is operable to cause the terminal device to one of:
determine at least one of a start of the PUSCH symbols as the start point for the PUSCH symbols or a start of the SBFD symbols as the start point for the at least one DMRS symbol;
determine at least one of the start of the SBFD symbols as the start point for the PUSCH symbols or the start of the PUSCH symbols as the start point for the at least one DMRS symbol if at least one of the at least one DMRS symbol is within the SBFD symbols; or
determine at least one of the start of the SBFD symbols as the start point for the PUSCH symbols or the start point for the at least one DMRS symbol.

4. The terminal device of claim 1, wherein, to determine the at least one symbol for the DMRS transmission, the at least one processor is operable to cause the terminal device to determine a resource allocation of the at least one DMRS symbol based on a duration of PUSCH symbols within the SBFD symbols.

5. The terminal device of claim 4, wherein the duration is from a first symbol of the SBFD symbols to one of a last symbol of the PUSCH symbols if a number of the PUSCH symbols is smaller than a number of SBFD symbols; or the last symbol of the SBFD symbols if the number of the PUSCH symbols is larger than the number of SBFD symbols.

6. The terminal device of claim 4, wherein the duration is from a first symbol of the PUSCH symbols to one of a last symbol of the PUSCH symbols if the PUSCH symbols are within a number of SBFD symbols; or the last symbol of the PUSCH symbols within the SBFD symbols if at least one of the PUSCH symbols is outside of the SBFD symbols.

7. The terminal device of claim 6, wherein one of:
the first symbol of the PUSCH symbols is a DMRS symbol if the PUSCH symbols are within the number of SBFD symbols; or
the first symbol of the SBFD symbols is the DMRS symbol if at least one of the PUSCH symbols is outside of the SBFD symbols.

8. The terminal device of claim 1, wherein the at least one processor is further configured to cause the terminal device to:
receive a second configuration indicating at least one of a start point for the PUSCH symbols or a start point for the at least one DMRS symbol; and
determine, based on the second configuration, at least one of the start point for the PUSCH symbols or the start point for the at least one DMRS symbol.

9. The terminal device of claim 8, wherein the start point for the PUSCH symbols or the start point for the at least one DMRS symbol is a DL symbol or a SBFD symbol.

10. The terminal device of claim 1, wherein the first configuration comprises at least one of:
a first indication of whether PUSCH repetitions counted on a basis of available slots is enabled;
a second indication of whether to use additional DMRS symbols; or
a third indication of a start symbol index for the DMRS transmission.

11. The terminal device of claim 1, wherein a resource allocation of the PUSCH symbols is indicated on top of an uplink (UL) slot that is involved in the PUSCH repetitions.

12. The terminal device of any of claim 1, wherein the at least one processor is further configured to cause the terminal device to:
preserve the PUSCH symbols if the PUSCH symbols are within the SBFD symbols; and
puncture at least one of the PUSCH symbols outside of the SBFD symbols if the at least one of the PUSCH symbols is outside of the SBFD symbols.

13. A network device for wireless communication, comprising:
at least one memory; and
at least one processor coupled with the at least one memory and operable to cause the network device, to:
transmit a configuration for physical uplink shared channel (PUSCH) repetitions and a demodulation reference signal (DMRS);
determine, based on the configuration, at least one of a start point for PUSCH symbols or a start point for at least one DMRS symbol in a downlink (DL) slot with subband full duplex (SBFD) symbols; and
monitor, based on the at least one of the start point for the PUSCH symbols or the start point for the at least one DMRS symbol, at least one symbol for PUSCH transmission and at least one symbol for DMRS transmission in the DL slot with the SBFD symbols.

14. A method performed by a terminal device, the method comprising:
receiving a configuration for physical uplink shared channel (PUSCH) repetitions and a demodulation reference signal (DMRS);
determining, based on the configuration, at least one of a start point for PUSCH symbols or a start point for at least one DMRS symbol in a downlink (DL) slot with subband full duplex (SBFD) symbols; and
determining, based on the at least one of the start point for the PUSCH symbols or the start point for the at least one DMRS symbol, at least one symbol for PUSCH transmission and at least one symbol for DMRS transmission in the DL slot with the SBFD symbols.

15. A method performed by a network device, the method comprising:
transmitting a configuration for physical uplink shared channel (PUSCH) repetitions and a demodulation reference signal (DMRS);
determining, based on the configuration, at least one of a start point for PUSCH symbols or a start point for at least one DMRS symbol in a downlink (DL) slot with subband full duplex (SBFD) symbols; and
monitoring, based on the at least one of the start point for the PUSCH symbols or the start point for the at least one DMRS symbol, at least one symbol for PUSCH transmission and at least one symbol for DMRS transmission in the DL slot with the SBFD symbols.

16. The method of claim 14, to determine the at least one of the start point for the PUSCH symbols or the start point for the at least one DMRS symbol, the method further comprising:
determining at least one of a start of the DL slot as the start point for the PUSCH symbols or a start of the SBFD symbols as the start point for the at least one DMRS symbol;
determining at least one of the start of the SBFD symbols as the start point for the PUSCH symbols or the start of the DL slot as the start point for the at least one DMRS symbol if the at least one DMRS symbol is within the SBFD symbols; or
determining the start of the SBFD symbols as at least one of the start point for the PUSCH symbols or the start point for the at least one DMRS symbol.

17. The method of claim 14, to determine the at least one of the start point for the PUSCH symbols or the start point for the at least one DMRS symbol, the method further comprising:
determining at least one of a start of the PUSCH symbols as the start point for the PUSCH symbols or a start of the SBFD symbols as the start point for the at least one DMRS symbol;
determining at least one of the start of the SBFD symbols as the start point for the PUSCH symbols or the start of the PUSCH symbols as the start point for the at least one DMRS symbol if at least one of the at least one DMRS symbol is within the SBFD symbols; or
determining at least one of the start of the SBFD symbols as the start point for the PUSCH symbols or the start point for the at least one DMRS symbol.

18. The method of claim 14, wherein to determine the at least one symbol for the DMRS transmission, the method further comprising determining a resource allocation of the at least one DMRS symbol based on a duration of PUSCH symbols within the SBFD symbols.

19. The method of claim 18, wherein the duration is from a first symbol of the SBFD symbols to one of a last symbol of the PUSCH symbols if a number of the PUSCH symbols is smaller than a number of SBFD symbols; or the last symbol of the SBFD symbols if the number of the PUSCH symbols is larger than the number of SBFD symbols.

20. The method of claim 18, wherein the duration is from a first symbol of the PUSCH symbols to one of a last symbol of the PUSCH symbols if the PUSCH symbols are within a number of SBFD symbols; or the last symbol of the PUSCH symbols within the SBFD symbols if at least one of the PUSCH symbols is outside of the SBFD symbols.
